(19) United States
(12) Patent Application Publication
(10) Pub. No.: US 2013/0302215 A1
(43) Pub. Date: Nov. 14, 2013

(54) COMBINATION DIELECTRIC BARRIER DISCHARGE REACTOR

(71) Applicant: Hua-Ming LIU, JIANGSU (CN)

(72) Inventor: Hua-Ming LIU, JIANGSU (CN)

(21) Appl. No.: 13/468,303

(22) Filed: May 10, 2012

(51) Int. Cl. B01J 19/08

(52) U.S. Cl. 422/186.04

(57) ABSTRACT

A combination dielectric barrier discharge reactor includes a rectangular or cylindrical electrically insulative housing and a plurality of reactor units arranged in a parallel or series manner in the housing in a rectangular or circular array. Each reactor unit includes a hollow cylindrical electrode and a rod electrode extending along the longitudinal axis of the hollow cylindrical electrode and a DC working voltage 6 kv-500 kv applied to each reactor unit between the respective hollow cylindrical electrode and the respective rod electrode. The combination dielectric barrier discharge reactor is a modularized structure constructed subject to actual requirements, practical for decomposing waste lubricating oil, insulation oil, milling oil and smokes discharged from a kitchen, smoking room, motor vehicle or machine.

### BACKGROUND OF THE INVENTION

1. Field of the Invention

The present invention relates to dielectric barrier discharge reactor technology and more particularly, to a combination dielectric barrier discharge reactor for discharging a high voltage to kill microbes and to decompose oil and smoke pollutants, so that the discharge gas providing purified air is in conformity with environmental health standards.

2. Description of the Related Art

Edible oil and foods will produce thermal decomposition products when cooked at a high temperature. These thermal decomposition products will disperse in air in the form of greasy flue gas. The composition of this greasy flue gas is complicated. It contains aldehyde, ketone, hydrocarbon, fatty acid, alcohol, aromatic compounds, esters, lactones and heterocyclic compounds. Among these substances, benzopyrene, volatile nitrosamines, heterocyclic amines are high carcinogens ever known. Through a large amount of scientific investigations and clinical analyses, scientists obtain the conclusion: Fatty amine oxides in the fumes from the kitchen may lead to cardiovascular and cerebrovascular diseases, more particularly to aged people. According to statistics provided by nutrition associations from different countries, people who smell the fumes daily are more easy to get cardiovascular and cerebrovascular diseases than those who do not smell the fumes because the fumes contain a large amount of cholesterol.

Further, researchers have discovered that smoking is the precipitating factor for lung cancer. At the present time, smokers around the world are quite a lot. Further, the ratio of male smokers is greater than female smokers. Many people suffer from passive smoking at home. The main victims of passive smoking are women and children.

Further, metalworking lubricants in the course of their work will produce oil mist, in which, droplet particles ≦5 um will be dispersed in air, causing harm to humans and leading to some occupational diseases. The fact that hydrocarbon oil mist can cause air pollution has received the full attention of the human. A metalworking lubricant is a complicated compound, which contains, in additional hydrocarbons, sulfonate, fatty amines, nitrates, colorings, fungicides and other chemicals. During metal cutting working, due to oxidation of hydrocarbons, growth of microbes or contamination of external impurities, the applied metalworking lubricant will contain many more chemical substances that are harmful to human and ecological environment. Either cigarette smoke, kitchen fumes, or smokes produced by metalworking lubricants or cutting fluids can cause pollution to the environment and are harmful to human health. Only a small percentage of factories would collect and treat waste smokes. A large percentage of factories use range hoods to directly discharge waste smokes to the outside open air, enabling waste smokes to be dispersed in air. The discharged waste smokes may sink to the ground. However, a certain amount of the discharge waste smokes may be inhaled by people, causing damage to people's health.

### SUMMARY OF THE INVENTION

The present invention has been accomplished under the circumstances in view. The main advantage of the combination dielectric barrier discharge reactor of the present invention is its high voltage discharging design. The rod electrode discharges a high voltage to the hollow cylindrical electrode at a short distance. The circumference of the rod electrode is the charge release side. The hollow cylindrical electrode is processed to provide transverse slots that are alternatively arranged in reversed directions at a predetermined angle relative to the longitudinal axis of the rod electrode. The hollow cylindrical electrode can also be made of spirally rotated a metal wire rod to enhance the charge discharging intensity. The high-speed ion flow between the rod electrode and the hollow cylindrical electrode carries high kinetic energy capable of decomposing fumes and re-combining them into water, carbon dioxide, nitrogen and other stable substances for discharge to the outside. Multiple rector units can be connected in parallel and arranged in a circular, rectangular or other shape of array. Multiple arrays of rector units can then be arranged into a combination dielectric barrier discharge reactor subject to the desired size. The size of the combination dielectric barrier discharge reactor and the number of reactor units can be arranged subject to the decomposition speed desired and the kind of smoke to be treated.

When compared to conventional designs, the he combination dielectric barrier discharge reactor of the present invention can be assembled subject to the desired size and treating capacity and the type of smoke to be treated. By means of adjusting parameters, such as the size of the hollow cylindrical electrode, the level of the applied voltage, the gap between the hollow cylindrical electrode and the rod electrode and he power level, the combination dielectric barrier discharge reactor can be configured for continuously and largely decompose cigarette smoke, kitchen fumes, or smokes produced by metalworking lubricants or cutting fluids.

### BRIEF DESCRIPTION OF THE DRAWINGS

FIG. 1 is a schematic drawing illustrating a combination dielectric barrier discharge reactor in accordance with a first embodiment of the present invention.

FIG. 2 is a schematic drawing illustrating a combination dielectric barrier discharge reactor in accordance with a second embodiment of the present invention.

FIG. 3 is an elevational view of one reactor unit of the combination dielectric barrier discharge reactor in accordance with the first embodiment of the present invention.

FIG. 4 is an elevational view of a reactor unit for combination dielectric barrier discharge reactor in accordance with a third embodiment of the present invention.

FIG. 5 is a schematic plain view of a hollow cylindrical electrode for the combination dielectric barrier discharge reactor in accordance with the first embodiment of the present invention.

FIG. 6 is a schematic plain view of a hollow cylindrical electrode for the combination dielectric barrier discharge reactor in accordance with the third embodiment of the present invention.

FIG. 7 is an elevational view of a part of a combination dielectric barrier discharge reactor in accordance with a fourth embodiment of the present invention.

FIG. 8 is a schematic drawing illustrating an application example of the present invention.

FIG. 9 is a schematic drawing illustrating another application example of the present invention.

### DETAILED DESCRIPTION OF THE PREFERRED EMBODIMENT

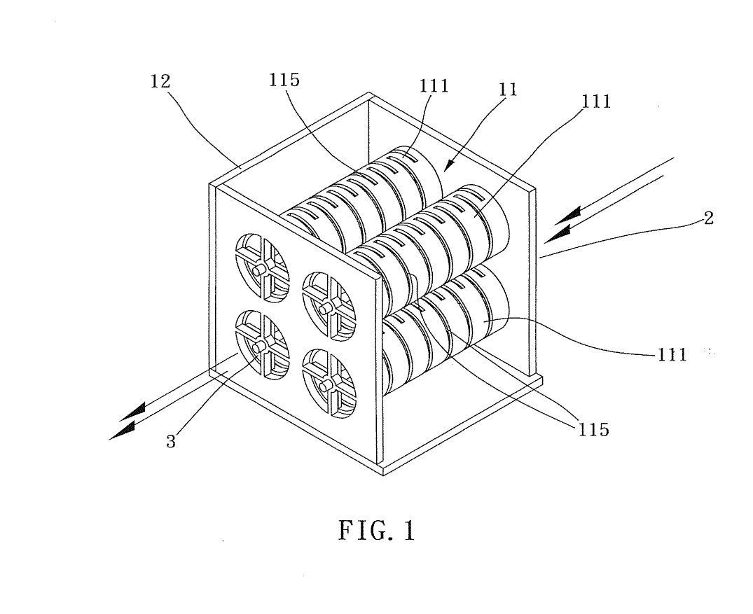

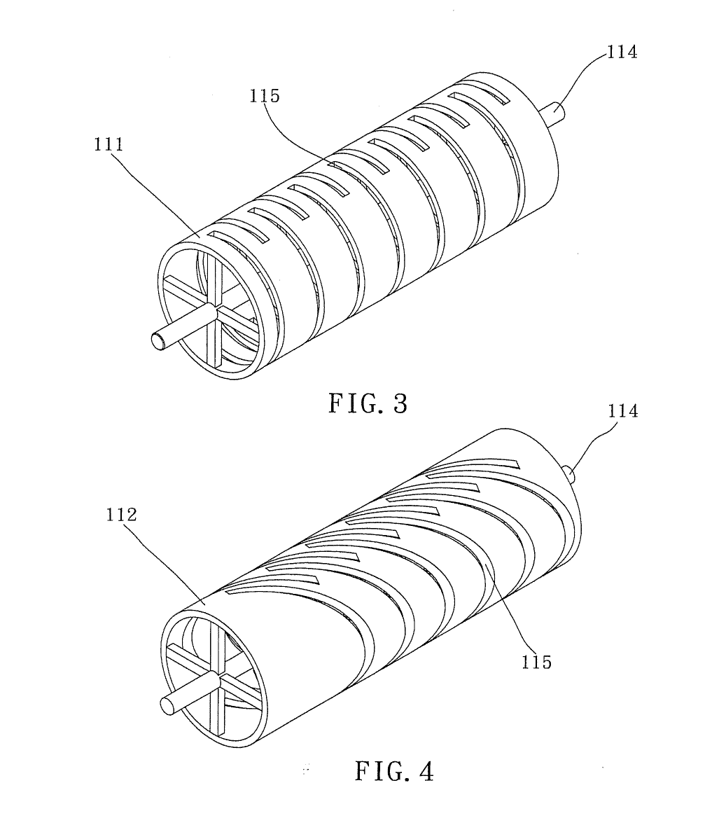

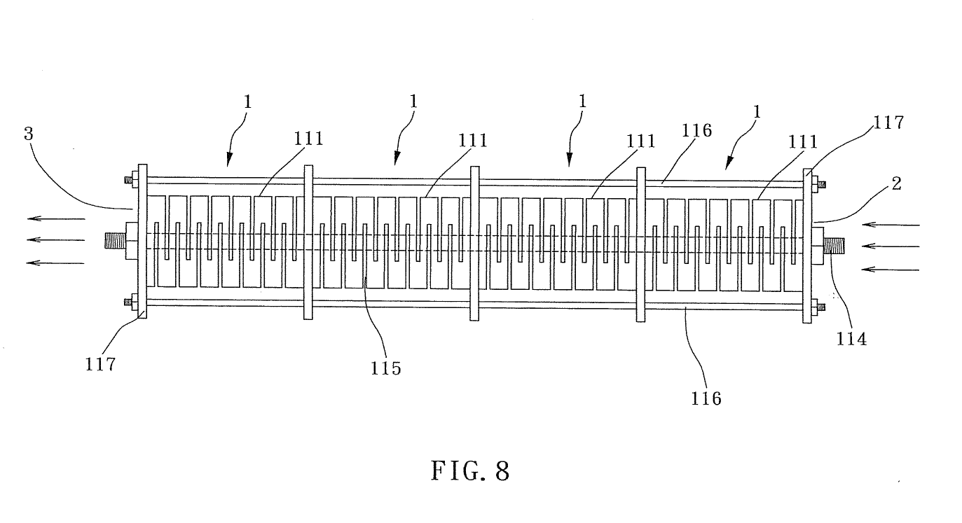

Referring to FIGS. 1, 3 and 5, a combination dielectric barrier discharge reactor 1 in accordance with a first embodiment of the present invention is shown comprising an electrically insulative rectangular housing 12 and four reactor units 11 mounted in the electrically insulative rectangular housing 12 and connected in parallel. The electrically insulative rectangular housing 12 comprises at least one air inlet 2 disposed at one end thereof for receiving the gas to be treated and a plurality of air outlets 3 disposed at an opposite end thereof for discharge of purified gas. Further, each reactor unit 11 comprises a hollow cylindrical electrode 111 and a rod electrode 114. The hollow cylindrical electrode 111 has an inner diameter of 80 mm and a wall thickness of 0.5 mm. The rod electrode 114 has a diameter of 8 mm. The rod electrode 114 is positioned in the axis of the hollow cylindrical electrode 111 and supported in position by two end brackets of the hollow cylindrical electrode 111. The hollow cylindrical electrode 111 comprises a plurality of transverse slots 115 cut through the peripheral wall thereof at 90° angle relative to the longitudinal axis of the rod electrode 114 and alternatively arranged in reversed directions. According to this first embodiment, the hollow cylindrical electrodes 111 of the four reactor units 11 are electrically connected in parallel to DC voltage ground line, and the rod electrodes 114 of the four reactor units 11 are electrically connected in parallel to +10 kv DC voltage. Further, four combination dielectric barrier discharge reactors 1 can be connected in series to form a combination dielectric barrier discharge reactor assembly having an air inlet 2 disposed at one end thereof for receiving the gas to be treated and an air outlet 3 disposed at an opposite end thereof for discharge of purified gas (see FIG. 8).

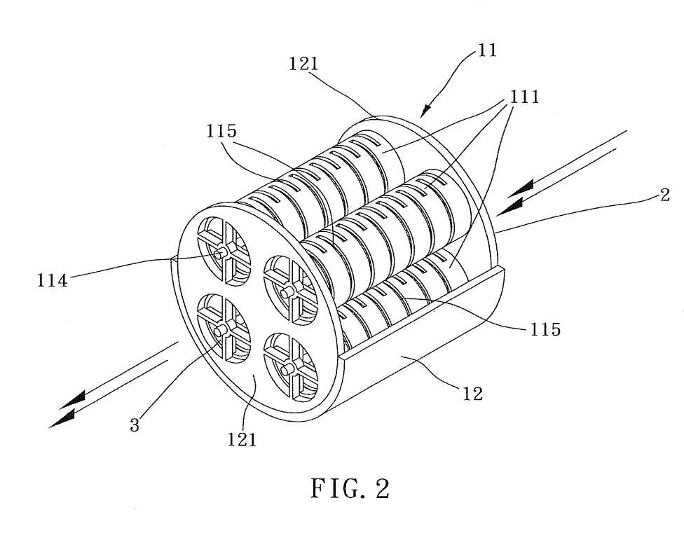

Referring to FIG. 2, a combination dielectric barrier discharge reactor 1 in accordance with a second embodiment of the present invention is shown comprising an electrically insulative cylindrical housing 12 and four reactor units 11 mounted in the electrically insulative cylindrical housing 12 and connected in parallel. The electrically insulative rectangular housing 12 comprises at least one air inlet 2 disposed at one end thereof for receiving the gas to be treated and a plurality of air outlets 3 disposed at an opposite end thereof for discharge of purified gas. The electrically insulative cylindrical housing 12 comprises two circular end caps 121 respectively disposed at two opposing ends thereof and configured to support the four reactor units 11 (for example, each circular end cap 121 has four round holes and a bracket disposed in each round hole for supporting the four reactor units 11). Each reactor unit 11 comprises a hollow cylindrical electrode 111 and a rod electrode 114. The hollow cylindrical electrode 111 has an inner diameter of 70 mm and a wall thickness of 0.8 mm. The rod electrode 114 has a diameter of 10 mm. The rod electrode 114 is positioned in the axis of the hollow cylindrical electrode 111 and supported in position by two end brackets of the hollow cylindrical electrode 111. The hollow cylindrical electrode 111 comprises a plurality of transverse slots 115 cut through the peripheral wall thereof at 90° angle relative to the longitudinal axis of the rod electrode 114 and alternatively arranged in reversed directions. According to this second embodiment, the hollow cylindrical electrodes 111 of the four reactor units 11 are electrically connected in parallel to DC voltage ground line, and the rod electrodes 114 of the four reactor units 11 are electrically connected in parallel to −15 kv DC voltage.

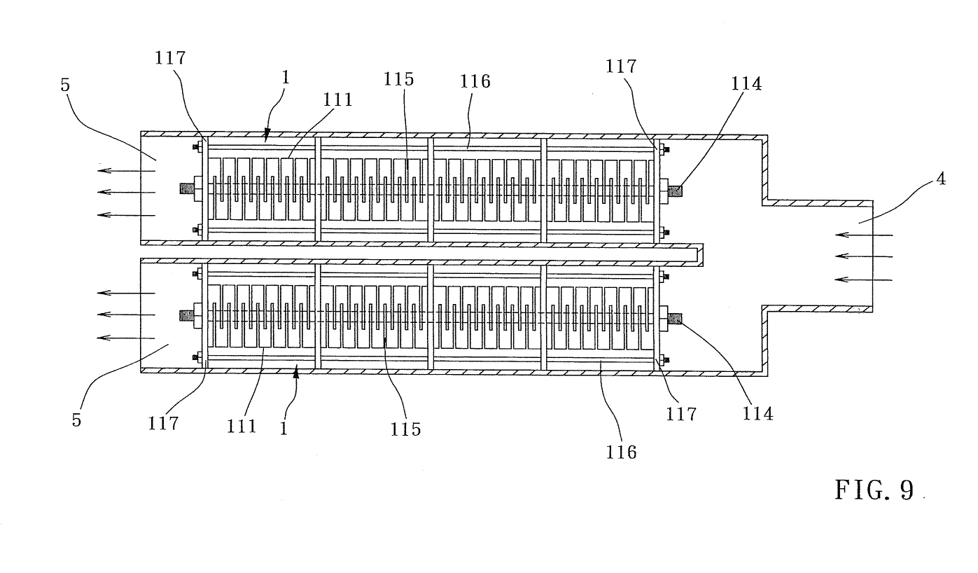

Referring to FIG. 9, three combination dielectric barrier discharge reactors 1 can be connected in series to form a combination dielectric barrier discharge reactor assembly having an air inlet 4 disposed at one end thereof for receiving the gas to be treated and a plurality of air outlets 5 disposed at an opposite end thereof for discharge of purified gas.

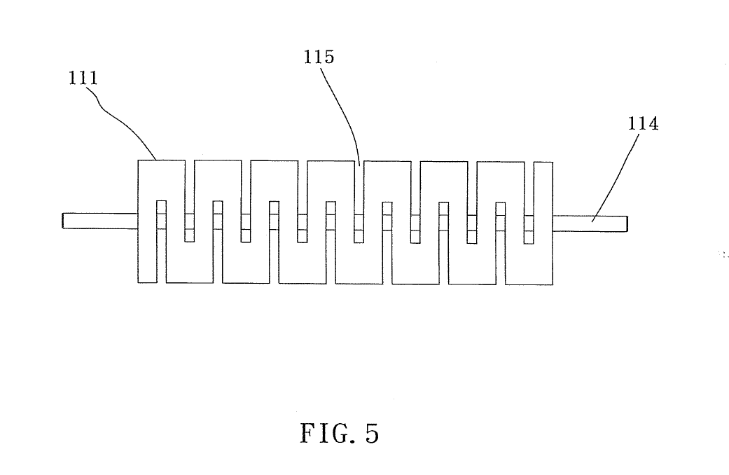

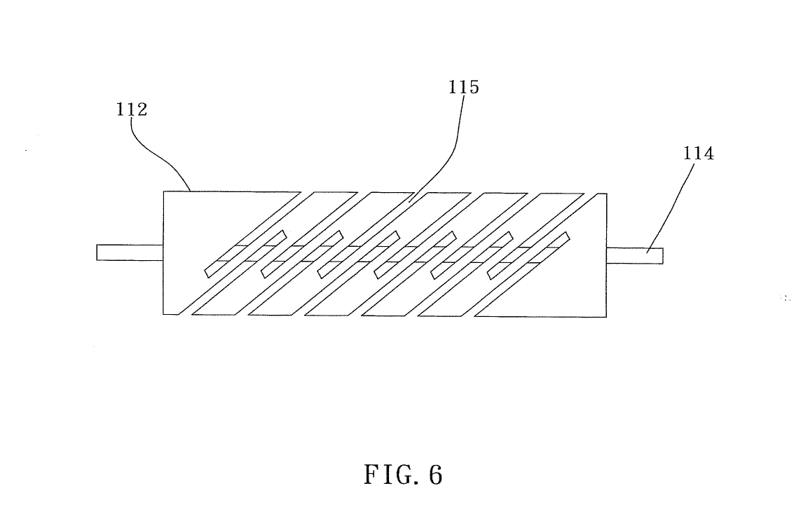

Further, an electrically insulative cylindrical housing 12 shown in FIG. 2 can be assembled with three reactor units 11 to form a combination dielectric barrier discharge reactor 1 in accordance with a third embodiment of the present invention. According to this third embodiment, these three reactor units 11 are mounted in the electrically insulative cylindrical housing 12 in a triangular arrangement. The electrically insulative cylindrical housing 12 comprises two circular end caps 121 respectively disposed at two opposing ends thereof and configured to support the four reactor units 11 (for example, each circular end cap 121 has three round holes and a bracket disposed in each round hole for supporting the four reactor units 11). As shown in FIGS. 4 and 6, each reactor unit 11 comprises a hollow cylindrical electrode 112 and a rod electrode 114. The hollow cylindrical electrode 112 has an inner diameter of 160 mm and a wall thickness of 1 mm. The rod electrode 114 has a diameter of 60 mm. The rod electrode 114 is positioned in the axis of the hollow cylindrical electrode 112 and supported in position by two end brackets of the hollow cylindrical electrode 112. The hollow cylindrical electrode 112 comprises a plurality of oblique slots 115 cut through the peripheral wall thereof at about 45° angle relative to the longitudinal axis of the rod electrode 114 and alternatively arranged in reversed directions. According to this third embodiment, the hollow cylindrical electrodes 112 of the four reactor units 11 are electrically connected in parallel to DC voltage ground line, and the rod electrodes 114 of the three reactor units 11 are electrically connected in parallel to −8 kv DC voltage.

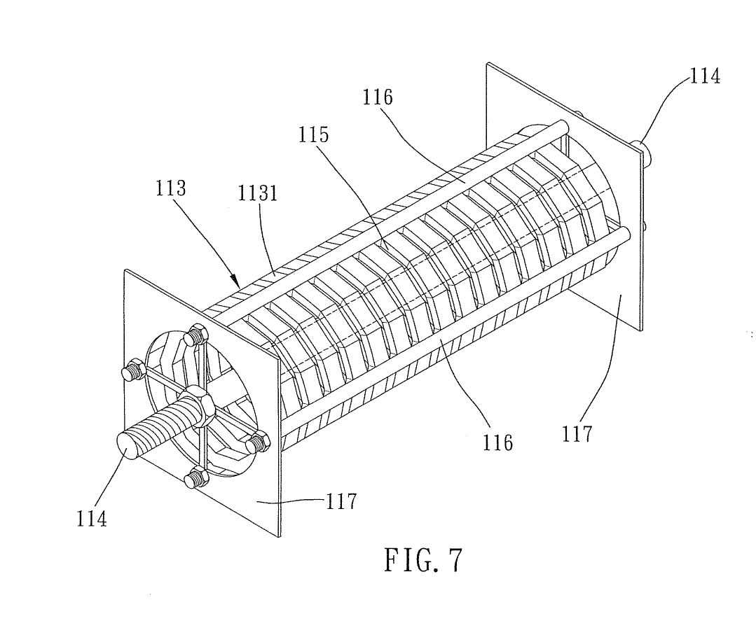

Referring to FIG. 7, a combination dielectric barrier discharge reactor in accordance with a fourth embodiment of the present invention is shown comprising an electrically insulative rectangular housing (not shown) and a plurality of reactor units mounted in the electrically insulative rectangular housing and connected in parallel, wherein each reactor unit comprises a spiral electrode 113, a rod electrode 114, tie rods 116, end plates 117. The end plates 117 are configured subject to the configuration of the electrically insulative rectangular housing and respectively fixedly mounted in the electrically insulative rectangular housing at two opposing sides. The tie rods 116 are connected between the end plates 117 to support the spiral electrode 113. The rod electrode 114 is mounted in the end plates 117 and surrounded by the spiral electrode 113 and extending along the central axis of the spiral electrode 113. The spiral electrode 113 is made by spirally rotating a metal wire rod 1131 into a cylindrical shape so that a spiral slot 115 is defined in the spiral electrode 113. The rod electrode 114 is connected to the negative pole of a high voltage DC power source. During application, the rod electrode 114 is connected to −10 kv DC and the spiral electrode 113 is grounded. When the combination dielectric barrier discharge reactor is electrically conducted, the gas to be treated is guided into one end of the rod electrode 114 and the purified gas is discharged through the other end of the rod electrode 114. Further, multiple reactor units can be connected in series or in parallel to form a combination dielectric barrier discharge reactor.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A combination dielectric barrier discharge reactor, comprising an electrically insulative housing and a plurality of reactor units selectively arranged in a parallel or series manner in said electrically insulative housing in an array, each said reactor unit comprising a hollow cylindrical electrode and a rod electrode extending along the longitudinal axis of said hollow cylindrical electrode and a DC working voltage within the range of 6 kv-500 kv applied to each said reactor unit between the respective hollow cylindrical electrode and the respective rod electrode.

2. The combination dielectric barrier discharge reactor as claimed in claim 1, wherein said reactor units are arranged in a parallel manner in said electrically insulative housing in a rectangular array.

3. The combination dielectric barrier discharge reactor as claimed in claim 1, wherein said reactor units are arranged in a parallel manner in said electrically insulative housing in a circular array.

4. The combination dielectric barrier discharge reactor as claimed in claim 1, wherein said hollow cylindrical electrode is formed of a spirally rotated a metal wire rod, comprising an inner diameter within the range of 10-2000 mm, a wall thickness over 0.1 mm, a plurality of transverse slots cut through the peripheral wall thereof at 90° angle relative to the longitudinal axis of said rod electrode and alternatively arranged in reversed directions.

5. The combination dielectric barrier discharge reactor as claimed in claim 1, wherein said hollow cylindrical electrode comprises a plurality of oblique slots cut through the peripheral wall thereof at a predetermined angle relative to the longitudinal axis of said rod electrode and alternatively arranged in reversed directions.

6. The combination dielectric barrier discharge reactor as claimed in claim 1, wherein said hollow cylindrical electrode defines a spiral slot therein.

7. The combination dielectric barrier discharge reactor as claimed in claim 1, wherein the rod electrodes of said reactor units are connected in parallel; the hollow cylindrical electrodes of said reactor units are connected in parallel.

8. The combination dielectric barrier discharge reactor as claimed in claim 1, wherein the rod electrode of each said reactor unit is selectively connectable to DC negative pole or DC positive pole; the hollow cylindrical electrode of each said reactor unit is grounded when the rod electrode of each said reactor unit is lying idle or connected to DC negative pole; the hollow cylindrical electrode of each said reactor unit is grounded when the rod electrode of each said reactor unit is lying idle or connected to DC positive pole.

9. The combination dielectric barrier discharge reactor as claimed in claim 1, wherein the rod electrode and hollow cylindrical electrode of each said reactor unit are made of an electric conductive material.
